(19) United States
(12) Patent Application Publication
(10) Pub. No.: US 2009/0089243 A1
(43) Pub. Date: Apr. 2, 2009

(54) Method and apparatus for handling of information

(76) Inventor: Sture Udd, Vaasa (FI)

Correspondence Address: BIRCH STEWART KOLASCH & BIRCH, PO BOX 747, FALLS CHURCH, VA, 22040-0747, US

(21) Appl. No.: 11/918,792

(22) PCT Filed: Apr. 18, 2006
(86) PCT No.: PCT/FI2006/050154

§ 371 Date: Mar. 21, 2008

(30) Foreign Application Priority Data
Apr. 18, 2005 (FI) 20055179

(51) Int. Cl. G06F 17/30; G06Q 40/00

(52) U.S. Cl. 707/2; 707/3; 705/39; 707/E17.001

(57) ABSTRACT

The invention relates to a method and an arrangement for handling information in a customer device. The method comprises forming an information recording in the customer device from an external information source in respect of the customer device, forming a delimited information recording from the information recording on the basis of manual or automatic delimitation, and showing one or more resulting information contents associated with the delimited information recording.

### FIELD

The invention relates to handling information in a customer device.

### BACKGROUND

Huge amounts of information are stored in information networks such as the Internet, for instance. Large amounts of information set strict requirements for information search routines and programs to be used. Search engines based on search of words currently operate fairly fast and are otherwise also far advanced. What can in turn be considered as a significant limitation is the delimitation of the search to searches of only textual mode.

A development for improving the searches is described in patent publication FI105954 and U.S. Pat. No. 5,933,829. These publications describe the search of a predetermined information content by means of a search code formed in the printed media, which may either be in text or image mode.

A corresponding application is known from the so-called intelligent magazine, the application being based on the fact that a mobile station is used to portray an intelligent frame advertisement formed in the printed media, a search condition is formed of the photograph by means of a link table, and the search condition is used to establish a connection to a particular pre-determined web site to be shown on the display of the mobile station.

However, the above arrangements still employ scarcely the possibilities to retrieve information from large amounts of information.

### BRIEF DESCRIPTION

It is an object of the invention to provide a method and an apparatus implementing the method so as to solve the above problems. The object of the invention is achieved with a method for handling information in a customer device. The method comprises forming an information recording in the customer device from an external information source in respect of the customer device, forming a delimited information recording from the information recording using manual or automatic delimitation, and showing one or more resulting information contents associated with the delimited information recording in the customer device.

The invention also relates to an arrangement for handling information. The arrangement comprises means for forming in a customer device an information recording in respect of the customer device from an external information source, means for forming a delimited information recording from the information recording using manual or automatic delimitation and means for showing one or more resulting information contents associated with the delimited information recording.

The invention further relates to a sub-configuration for a customer device comprising means for selecting an information recording as input data. The sub-configuration also comprises means for forming a delimited information recording from the information recording using manual or automatic delimitation and means for showing one or more resulting information contents associated with the delimited information recording.

The invention also relates to a mobile station comprising means for forming an information recording. The mobile station comprises means for defining a delimited information recording from the information recording using manual or automatic delimitation, and means for showing one or more information contents associated with the delimited information recording.

The preferred embodiments of the invention are disclosed in the dependent claims.

The invention relates to handling, or processing, information in a customer device. In an embodiment the customer device communicates with an information network, which refers to a public or limited information network. An example of a public information network is the Internet and a limited information network may refer to a specific internal information network of a museum, for instance.

The customer device refers to such a device that may communicate with a separate information network in respect of the customer device. The customer device may comprise electronic, chemical and biological device parts. In an embodiment the customer device is a mobile station but it may also refer for instance to a portable computer, or an information surface, such as a smart component or similar fastened to a garment. It is apparent that when the customer device is a mobile phone, a mobile network serving the mobile phone may be provided between the customer device and the information network.

In this invention the sub-configuration refers for instance to an entity formed of device parts intended to be used with a mobile phone in order to implement a certain functionality.

In the solution according to the invention an information recording is formed in the customer device. In an embodiment the information recording is an image file, or what is known as a freeze-frame, which may be stored in digital mode for instance in JPEG (Joint Photographic Expert Group) file storing format. Instead of a normal visual recording the image recording may for instance be a visual recording taken with a thermographic camera from an information source radiating infrared radiation. Furthermore the information recording may be a video take, which can be stored for instance in MPEG (Moving Pictures Expert Group) format or for instance an audio file. The modes of an information recording mentioned above are merely shown as examples without limiting the invention thereto. In other words, in addition to visible light the information to be stored may for instance be electromagnetic, magnetic or gravitation information.

In the invention a delimited information recording is formed from the information recording based either on manual delimitation carried out by the user or on automatic delimitation performed by the device. For instance when a freeze-frame is concerned the user may allocate the desired object from the freeze-frame and delimit the freeze-frame thereto. When a video recording is concerned, the user may delimit the original recording by focusing and/or limiting the time span of the original take to a particular part. Correspondingly, for instance the time span of the audio take can be limited.

In an embodiment of the invention information contents corresponding to a delimited information recording are retrieved from an information network connected to the customer device. The customer device may communicate with the information network either through a fixed connection or a connection to be connection-specifically established. In an embodiment the user may before carrying out the search define for instance a particular product group, to which the search according to the delimited information recording is focused. In an embodiment the user may also select an information network, an operator or a search program for carrying out the search. The customer terminal, such as a mobile phone, may carry out a preliminary evaluation about whether the quality of the information recording is adequate to allow carrying out a search based thereon or must the user of the customer device form a new information recording.

In an embodiment the delimited information recording is together with the additional definitions possibly defined by the user transferred to a server computer connected to the customer device. The server may be used to identify one or more image objects from the delimited information recording using a pattern recognition technique, for example. The image object can be identified for instance by comparing portions of the image file with predetermined image patterns. Alternatively the image file can be changed into digital data and the comparison can be carried out numerically. Based on the identification of the image objects the server may form for instance search words in text mode to be fed into a search engine and further to be used in a search to be carried out in the information network.

Instead of the server a specific customer device can also be used to carry out the identification of image objects. Thus, the user of the device takes an image for instance of the smart code, i.e. a two-dimensional matrix code. The matrix code is analyzed in the customer device and a multi-channel image analysis is obtained as a result. This means for instance that the code or the image automatically provides information on many levels that is shown in the device or the device sends the information independently to another device, such as a mobile station or a computer, communicating with the customer device. Alternatively an operation menu is formed as a result of the image analysis in the customer device. The operation menu is shown to the user and the user may select the desired operation. The operation menu may include various functionalities. For instance, the customer device may search from the information network information associated with the described object or the customer device may carry out an operative function, for instance perform a function stored in the device. The embodiment provides such an advantage that when all the assignments associated with image identification are carried out in the customer device, then security-critical functionalities associated for instance with banking services can be carried out. Another advantage is that the handling process of information is user specific, whereby the user is able to exert an influence on what information is provided and is not tied to the limited amount of information offered by an external server.

The result group including information contents obtained as a result of the search is shown to the user of the customer device. The result group may for instance be web links, an audio or video file or an operative application. The user of the device may select from the display of the device the information content desired to be examined in more detail or the user may for instance specify the result group by defining a new search word, product group or another limitation. Information can be shown in the specific customer device or in a peripheral device connected to the customer device. For example, when a mobile phone is concerned, the peripheral device may be a television connected to the mobile phone enabling to show the retrieved search result group. In the description of the invention the customer device refers to an entity formed of the customer device and the possible peripheral devices.

The method and the arrangement according to the invention may be used to retrieve for information from an information network significantly more flexibly than in the prior art.

### LIST OF DRAWINGS

The invention will be explained in greater detail by means of the preferred embodiments with reference to the accompanying drawings, in which

FIG. 1 shows an embodiment of the method, and

FIG. 2 shows an embodiment of the device arrangement.

### DESCRIPTION OF EMBODIMENTS

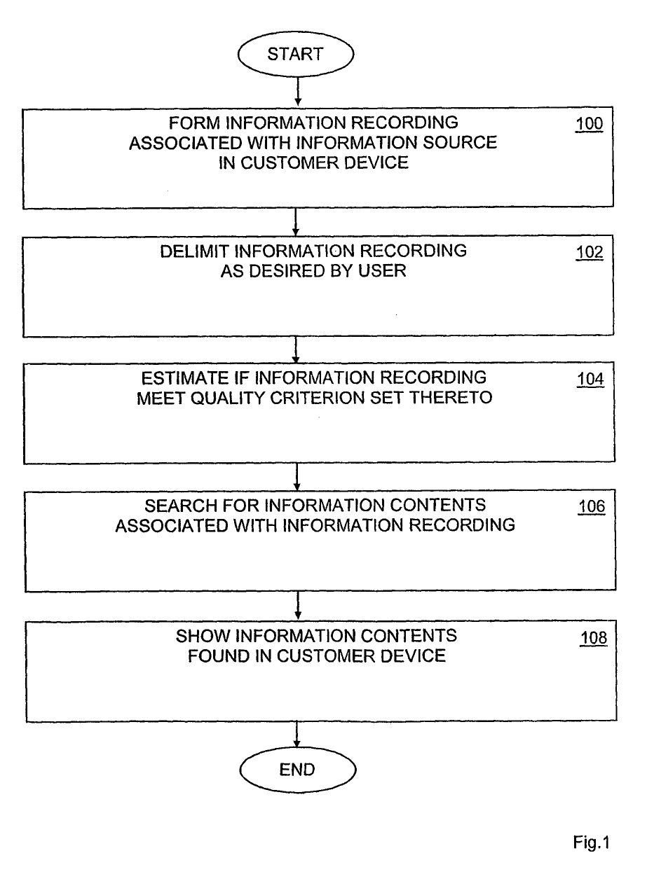

In the following the invention will be explained with reference to the accompanying Figures. FIG. 1 shows an embodiment of the method.

At the start of the method a customer apparatus is employed to form an information recording from an information source. The information source, from which the information recording is formed may for instance be a stationary object, a moving object or a sound object. The information included in the information recording is not limited to sound waves or visible light, but may refer to any wavelike radiation to be stored.

In an embodiment the object to be stored is a stationary object and the apparatus to be used for storing is for instance a mobile phone provided with a camera. The apparatus may for instance also be a digital camera, a portable computer or a corresponding device that can be used to form an information recording in digital mode of the object, such as an image file.

In step 100 the customer device is used to take a freely delimited image of a desired object and to form an image file of the image. Free delimitation means that the image can be arbitrarily created from the selected object without any predetermined definitions how the image should be delimited. Free delimitation therefore differs from for instance the intelligent frame application according to the prior art, in which an area defined in red is shown on the display of a mobile phone to which the intelligent frame is to be aligned. An image file is formed of the provided object, which image file may be shown in a known image file format, such as the JPEG format.

In step 102 the information recording is delimited as the user desires. As regards an image file, delimitation means that the image file is focused on a part of the original image file and a new and delimited image file is created from the focused part. It may for instance be considered that “a building”, “a statue” or “a car” were portrayed in the middle of a city as image objects in the original image file. The user of the device carries out a delimitation to the “car”, which forms the delimited image file. In an embodiment the alignment is conducted automatically in the device. The device may for instance by means of pattern recognition technique locate one or more image objects from the information recording formed and show the located image objects to the user for selection.

If the information recording is a video recording, then the limitation may refer to the focusing of image files as well as to the limitation of the time span of a file. For example, from a 20 seconds long video clip, a 3 seconds long portion may be taken from the 15-18 second interval in the clip. Correspondingly if the information recording is a sound file, the 15 second sound file may for instance be delimited to a 5 second portion.

In method step 104 it is estimated whether the information recording meets the quality criterion set thereto. Preferably step 104 is carried out in the customer device, whereby the customer device may in advance clarify whether the quality of the recording is adequate so that it may be utilized efficiently in the search. Concerning the image file the quality criterion may be associated with the distinctiveness or brightness of the image, whereas in a sound file the quality criterion may be associated with for instance the volume or the volume of the dominating sound entity in relation to the volume of the background noise or interference. The customer device may by means of pre-determined quality criteria immediately decide whether the information recording meets the quality criteria set thereto or should the user possibly form the (delimited) information recording again.

In step 106 information contents associated with the delimited information recording are retrieved. In an embodiment the user may define a search attribute, which is used together with the delimited information recording in order to perform the search. The search attribute may for instance refer to a product group, such as “kitchen fittings”. In an embodiment the user may define for instance the operator or the information network, where the search is to be carried out.

In an embodiment the customer device sends the delimited information recording together with the search attributes possibly defined by the user to a server computer communicating with the customer device. Applying known principles of pattern recognition or image recognition the server may identify one or more image objects from the information recording and on the basis of the recording form one or more search attributes, such as a search word. The search words formed on the basis of the image can together with the search words defined by the user be used to retrieve information contents from the information network. In an embodiment the server is not used to form search words, instead the delimited image recording is transferred as one search criterion with one or more possible search words formed by the device/user.

In step 106 especially the formation of search words based on the information recording is naturally not bound to a location, meaning that it is apparent that search words can also be formed for instance in the specific customer device. The retrieval of information contents from the information network can be carried out for instance using an Internet browser according to the prior art.

In step 108 the resulting information contents found are shown in the terminal. In an embodiment the display of the mobile phone shows one or more web links, from which the user may select the desired one for closer examination. The retrieved information contents can also be displayed using sound or as a combination of sound and image (freeze or video). In an embodiment the resulting information content is an operative application. For instance, if a moving object is portrayed with the device, the user may request the device to show an application that allows determining the direction and speed of the moving object.

In an embodiment the user may in step 108 delimit the result group by further feeding verbally or for instance orally an additional search word.

In a second embodiment of the method the functionality associated with the analysis of the image is carried out in the terminal. Thus, the image taking, the image/pattern recognition and the formation of operative functions based on the objects identified in the image are carried out in the terminal.

In an embodiment the user may take an image for instance from two image objects, for instance from an image and a text portion, from which the customer device forms for instance a two-dimensional matrix code. An operation defined in the terminal may be to transfer the created code automatically or approved by the user to another one from the terminal, in which case the mere code may show large amounts of information (image/text) in the background.

In another embodiment, while shopping in a store the user may portray a smart code of each product, and when all products are portrayed then a sum code can be formed of all the codes read. The sum code can be shown at the cash desk on the terminal of the recipient of the bill. The code formations mentioned above may be carried out automatically or as selected by the user.

In the solution according to an embodiment the user of the customer device is provided with a huge selection of choices how to utilize the portrayed information. Compared with solutions in which the image is sent to an external server the user practically has no chance to affect what is done with the information read from the image, instead the server carries out the predetermined (search) operations on the basis of the image. As the image analysis is carried out already in the terminal the user is provided with a significant chance to exert influence on the kind of information the user retrieves from the image. When an analysis is carried out of the image and the user is shown the operative possibilities already in the terminal, then the user may select the desired operation and is not bound to the search group offered by the server or the Internet server.

In an embodiment the reading technique can be utilized in such a manner that the user is able to read with the customer device the bar code/matrix code on the invoice, in which case the terminal automatically offers for instance a chance to shift over to the banking service in order to pay the invoice. In another embodiment the terminal stores the information but does not pay for it yet. In a third embodiment the user of the terminal may transfer the invoice for instance to a bank to be carried out as a mobile operation or the user may transfer the invoice to another terminal to pay the invoice. The user may also for instance carry out an inquiry about the invoice on the basis of the information on the invoice.

In an embodiment the user takes an image in a furniture shop of a desired couch. As a functionality the device may provide the user with a possibility to examine the couch virtually in combination with the user's living room. The user may connect the image taken of the couch to a smart code of paper that defines the location of the couch geometrically correctly in the desired surroundings. At home the user may place the smart code of paper on the floor of the room and take an image of the room, in which case the couch is placed at the location indicated by the smart code and it may be rotated as desired.

On account of the user-centricity the user may affect if desired the fact where to send the information and what to do with the analysed result.

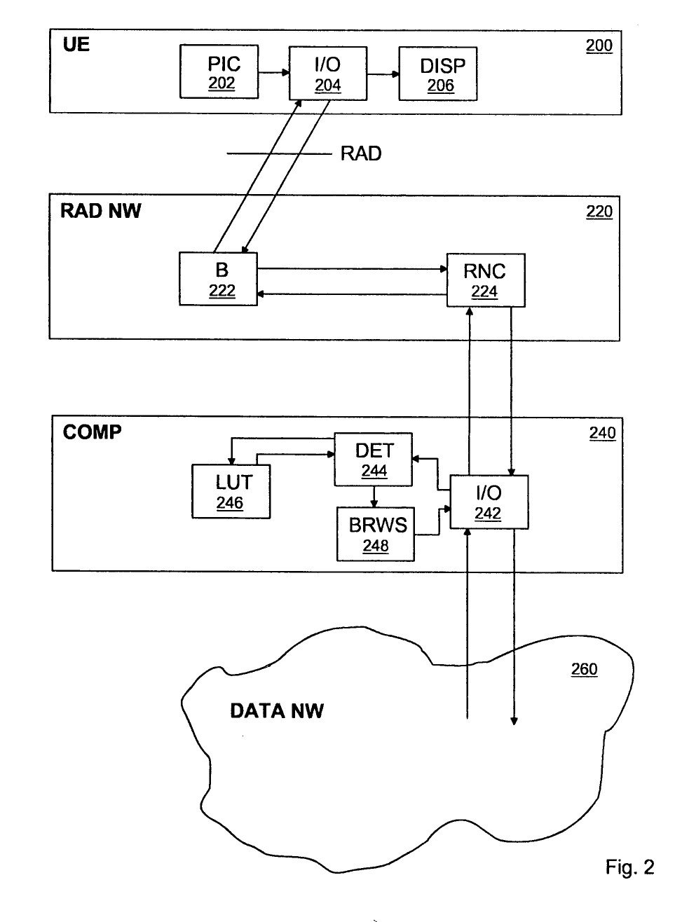

FIG. 2 shows by way of example an embodiment of the arrangement. In the embodiment shown in FIG. 2 the invention is portrayed in the case of an information recording in freeze-frame mode, but the invention can also be applied for instance to a moving image or to a sound recording mode.

The arrangement comprises a mobile station 200, a radio network 220, a server computer 240 and a data information network 260. In the following only the elements essential to the description of the invention are explained as regards the arrangement and each sub-complex 200, 220, 240 and 260 belonging to the arrangement. It is obvious that the arrangement and each of the sub-elements may include other device parts.

The mobile station 200 may comprise means 202 for creating an image file. Said means may for instance refer to a camera integrated into the mobile station or a digital camera, a telescope, a microscope or for instance an RFID identification communicating with the mobile station by means of a known transfer protocol.

An image taken with the camera 202 can be transferred to a unit 204 offering a user interface and intercommunications of the mobile station. What the user interface refers to is for instance the keyboard, microphone and loudspeakers of the mobile phone. The communications connection in turn refer to for instance apparatus components implementing the radio connection. In an embodiment the user may delimit by means of the user interface the original information recording taken with the camera 202 as desired and thus form the delimited information recording. In accordance with another embodiment the customer device forms a delimited information recording automatically. The information recording and/or the delimited information recording can be stored for instance in the memory of a mobile phone, which is not for the sake of simplicity shown in FIG. 2. The user interface 204 also allows the user to feed the desired search words to be used together with the delimited information recording when performing a search.

FIG. 2 illustrates how the mobile station 200 communicates through a radio interface (RAD) with a base station 222 included in a radio network 220. The radio connection may comprise a fixed data connection, such as the Internet connection. Thus the decentralisation of the functionality required by the arrangement for instance between the mobile station and the server operating in the data network is possible. The base station 222 implementing the radio connection directed to the mobile station 200 is controlled by a radio network controller 224.

The radio network 220 may for instance communicate through a fixed data connection with connection means 242 of a server computer 240.

In the embodiment shown in FIG. 2, an image is taken in the mobile station 200 that is transferred through the radio network to the server computer 240. In the server 240 the image is transferred to means 244 for identifying one or more image object from the image. The means 244 for identifying an image object may employ for instance a pattern recognition technique for the identification by utilizing the object patterns readily stored in a table 246. Pattern recognition can be carried out by comparing the image object pattern taken with a readily stored image object pattern or by digitizing an image that is taken and by carrying out the comparison numerically in respect of the pre-stored numerical data. As regards the invention, it is not essential how one or more image objects are identified from a taken image, for which purpose known prior art solutions can be used.

Based on the identification of image objects the identification means 244 may form one or more search words, on the basis of which the information associated with the image object can be retrieved from the information network 260. The server computer may show the search words formed to the user of the customer device 200 before carrying out the search. The user may then have a chance to modify the list by removing/adding search words.

The server computer 240 may comprise for instance an Internet browser 248, into which the search words are stored and transferred forward to the connection means 242 in order to carry out the search in the data network. As a reply to the search a web link list may be provided that can be transferred from the server 240 through the radio network 220 to the terminal 200 to be shown on the display 206 of the terminal 200.

Even though FIG. 2 shows the formation of search words and the processing of the image in the server computer 240, the image processing and particularly the pattern recognition can also be carried out in the customer device, whereby a separate server computer is not necessarily required.

The invention can be implemented for instance by software, as ASIC (Application Specific Integrated Circuit) or by means of separate logic components.

It is apparent to those skilled in the art that as technology progresses the basic idea of the invention can be implemented in various ways. The invention and the embodiments thereof are therefore not restricted to the examples described above but they may vary within the scope of the claims.

1-10. (canceled)

11. A method for handling information in a customer device, where the method comprises forming (100) an information recording in the customer device from an external information source in respect of the customer device, comprising:
forming (102) a delimited information recording from the information recording using manual or automatic delimitation,
analysing the delimited information recording at the customer device; and
providing, at the customer device, one or more functionalities executable by the customer device on the basis of the analysed delimited information recording.

12. A method as claimed in claim 11, further comprising:
retrieving one or more resulting information contents from an information network communicating with the customer device.

13. A method as claimed in claim 12, further comprising:
selecting one or more search attributes as input data from the user of the customer device, searching from the information network one or more resulting information contents on the basis of one or more search attributes selected as input data and the delimited information recording.

14. A method as claimed in claim 12, further comprising:
searching one or more resulting information contents from the information network defined by the user of the customer device and/or using the search instrument defined by the user.

15. A method as claimed in claim 11, further comprising:
estimating whether the quality of the information recording meets the quality criterion previously set thereto,
showing one or more resulting information contents associated with the information recording if the quality of the information recording meets the quality criterion set thereto.

16. A method as claimed in claim 11, further comprising:
showing one or more search attributes formed on the basis of the delimited information recording in the customer device to the user of the customer device,
selecting a specified search attribute group as input data from the user of the customer device, where at least some of the search attributes are changed compared with the one or more search attributes formed on the basis of the delimited information recording,
performing the search of the resulting information contents on the basis of the specified search attribute group.

17. An arrangement for handling information comprising means for forming (202) in a customer device (200) an information recording in respect of the customer device from an external information source, comprising:
means for forming (204) a delimited information recording from the information recording using manual or automatic delimitation,
means for analysing the delimited information recording at the customer device;
means for providing, at the customer device, one or more functionalities executable by the customer device on the basis of the analysed delimited information recording.

18. A sub-configuration for an electronic device comprising means for selecting an information recording as input data, comprising:
means for forming a delimited information recording from the information recording using manual or automatic delimitation,
means for analysing the delimited information recording at the customer device;
means for providing, at the customer device, one or more functionalities executable by the customer device on the basis of the analysed delimited information recording.

19. A mobile station, comprising
means for forming an information recording from an external information source;
means for forming a delimited information recording from the information recording using manual or automatic delimitation,
means for analysing the delimited information recording at the customer device,
means for providing, at the customer device, one or more functionalities executable by the customer device on the basis of the analysed delimited information recording.

20. A mobile station as claimed in claim 19, comprising:
means for selecting one or more search attributes from the user of the customer device as input data, and
means for searching from the information network connected to the mobile station one or more resulting information contents on the basis of one or more search attributes selected as input data and the delimited information recording.

21. A mobile station as claimed in claim 19, further comprising:
means for estimating whether the quality of the information recording meets the quality criterion previously set thereto,
means for showing one or more resulting information contents associated with the information recording if the quality of the information recording meets the quality criterion set thereto.

22. A mobile station as claimed in claim 19, further comprising:
means for showing one or more search attributes formed on the basis of the delimited information recording in the customer device to the user of the customer device,
means for selecting a specified search attribute group as input data from the user of the customer device, where at least some of the search attributes are changed compared with the one or more search attributes formed on the basis of the delimited information recording,
means for performing the search of the resulting information contents on the basis of the specified search attribute group.

23. A mobile station as claimed in claim 19, wherein the external information source comprises a two-dimensional data matrix code.

24. A mobile station as claimed in claim 19, wherein the one or more functionalities executable by the customer device comprises a security-critical banking service.

25. A mobile station as claimed in claim 19, wherein the external information source comprises a data matrix code on an invoice, and the one or more functionalities comprises paying of the invoice.

26. A mobile station as claimed in claim 19, wherein the external information source comprises a data matrix code on an invoice, and the one or more functionalities comprises performing an inquiry on the invoice on the basis of the information on the invoice.
